(19) United States
(12) Patent Application Publication
(10) Pub. No.: US 2015/0361663 A1
(43) Pub. Date: Dec. 17, 2015

(54) BUILDING MATERIAL AND METHOD FOR PRODUCING THE SAME

(71) Applicant: Nichiha Corporation, Nagoya-shi (JP)

(72) Inventors: Shinichi KANEKO, Nagoya-shi (JP); Takahiro YAMAGUCHI, Nagoya-shi (JP)

(73) Assignee: Nichiha Corporation, Nagoya-shi (JP)

(21) Appl. No.: 14/638,555

(22) Filed: Mar. 4, 2015

(30) Foreign Application Priority Data
Jun. 16, 2014 (JP) 2014-123477

(51) Int. Cl. E04C 2/02; C09D 183/06; C09D 133/08

(52) U.S. Cl. CPC E04C 2/02; C09D 133/08; C09D 183/06

(57) ABSTRACT

The invention relates to a highly durable building material and a method for producing the same. The building material prevents the substrate or an intermediate resin layer from being decomposed by photoradicals that may be generated from zinc oxide. Provided is a building material in which an ultraviolet protection layer containing zinc oxide particles and silica particles is formed directly on the surface of a substrate or indirectly with an intermediate resin layer interposed between the substrate and the ultraviolet protection layer. The silica particles are fixed to the substrate or the intermediate resin layer.

### CROSS REFERENCE TO RELATED APPLICATIONS

This application is based on Japanese Patent Application No. 2014-123477 filed with the Japanese Patent Office on Jun. 16, 2014, the entire content of which is hereby incorporated by reference.

### BACKGROUND OF THE INVENTION

1. Field of the Invention

The present invention relates to a building material including an ultraviolet protection layer, and a method for producing the same.

2. Description of the Related Art

In general, building materials such as roof materials, wall materials, and decorative materials that are subjected to ultraviolet exposure on the outside of buildings are provided with a protection against ultraviolet light.

For example, JP 2002-36442A relates to a coating structure in which an organic coating is formed on a substrate and a top coating film is formed as an uppermost layer, and discloses a coating structure in which the top coating film is constituted by a transparent silicone-based resin film containing zinc oxide as an inorganic ultraviolet absorber. JP 2002-36442A suggests that this coating structure can suppress photodegradation and the like effectively and for a long period of time. In addition, zinc oxide also has the capability of shielding from ultraviolet light, in addition to absorbing ultraviolet light. It is also known that this ultraviolet shielding effect can suppress the degradation of the coating by ultraviolet light.

### SUMMARY OF THE INVENTION

However, zinc oxide has the properties of being photoexcited to generate radicals (photoradicals), and causing the organic coating to be decomposed by the radicals. Accordingly, there is a concern that inclusion of zinc oxide in the transparent silicone resin film as described in JP 2002-36442A may lead to degradation of the organic coating.

The present invention has been made in view of the above-described concern, and relates to a building material including an ultraviolet protection layer containing zinc oxide on the surface of a substrate, and it is an object of the invention to provide a highly durable building material including an ultraviolet protection layer that does not cause the substrate or an intermediate resin layer to be decomposed by photoradicals that may be generated from zinc oxide, and a method for producing the same.

In order to achieve the above-described object, a building material according to the present invention includes: a substrate; and an ultraviolet protection layer containing zinc oxide particles and silica particles formed on a surface of the substrate, wherein the silica particles in the ultraviolet protection layer are fixed to the surface of the substrate.

### BRIEF DESCRIPTION OF THE DRAWINGS

FIG. 1 is an enlarged vertical cross-sectional view of a part of a building material according to Embodiment 1 of the present invention.

FIG. 2 is an enlarged vertical cross-sectional view of a part of a building material according to Embodiment 2 of the present invention.

### DESCRIPTION OF THE PREFERRED EMBODIMENTS

An embodiment is a building material in which an ultraviolet protection layer containing zinc oxide particles and silica particles are formed directly on a surface of a substrate or indirectly with an intermediate resin layer interposed between the substrate and the ultraviolet protection layer, wherein the silica particles are fixed to the substrate or the intermediate resin layer.

In the building material, the ultraviolet protection layer on the surface of the substrate is formed of zinc oxide particles and silica particles that are resistant to photoradicals. Accordingly, the silica particles serve as a binder to form the ultraviolet protection layer, and it is therefore possible to effectively solve the concern of degradation of the substrate or the intermediate resin layer, and the ultraviolet protection layer by photoradicals generated by the zinc oxide particles.

Here, the building material is directed to roof materials, wall materials, decorative materials, and the like that are subjected to ultraviolet exposure on the outside of buildings, as previously described.

Examples of the “substrate” forming the building material include a ceramic siding board composed mainly of cement, an ALC (autoclaved lightweight concrete) board, a metal siding board composed mainly of metal, and a resin board.

The “silica particles” forming the ultraviolet protection layer have the properties of having excellent hydrophilicity, being less prone to stain attachment, and allowing attached stains to be easily washed off with rain water or the like (the so-called self-cleaning performance, or self-cleaning effect). The silica particles also have binder force, and function as a binder that is bonded to zinc oxide particles to form a layer. Note that colloidal silica, fumed silica, or the like is used as the silica particles.

On the other hand, the “zinc oxide particles” forming the ultraviolet protection layer have the ultraviolet shielding effect.

Thus, the ultraviolet protection layer forming the building material is a layer including both the self-cleaning effect provided by the silica particles and the ultraviolet shielding effect provided by the zinc oxide particles.

For example, the zinc oxide particles and the silica particles forming the ultraviolet protection layer are configured as a whole by the silica particles disposed around the zinc oxide particles by intermolecular bonding. Also, the silica particles are fixed to the substrate or the intermediate resin layer serving as the underlying layer to form a building material. As used herein, to “being fixed to” means that silanol groups included in the silica particles and functional groups included in the substrate or the intermediate resin layer are bonded by hydrogen bonding or the like. Thus, the use of the silica particles allows the zinc oxide particles and the silica particles to be connected by intermolecular force, and the silica particles and the substrate or the intermediate resin layer to be connected by hydrogen bonding. Accordingly, it is possible to attach the zinc oxide particles to the surface of the substrate or the intermediate resin layer without using the organic binder as in the coating structure disclosed in JP 2002-36442A.

Further, since the silica particles surround the zinc oxide particles, it is possible to protect the substrate or the intermediate resin layer against photoradicals generated from zinc oxide, thus making it possible to increase the durability of the building material.

Examples of the related art include a technique as disclosed in JP 2002-36442A by which the zinc oxide is contained in the organic coating to provide the effect of absorbing ultraviolet light, and a technique by which a layer containing the silica particles is formed on the surface of a substrate to provide the self-cleaning effect. However, the technique that is focused on both the photoradical resistance and the binder property of the silica particles to achieve the ultraviolet shielding effect and the effect of protecting the substrate or the intermediate resin layer against photoradicals by disposing silica particles around zinc oxide particles to form a layer. Moreover, the application of this technique to building materials are an unprecedented, novel and original technical idea.

Examples of the configuration of the building material include a configuration in which an ultraviolet protection layer is directly formed on the surface of a substrate, with silica particles being fixed to the substrate, and a configuration in which a single or a plurality of intermediate resin layers are interposed between a substrate and an ultraviolet protection layer, with the silica particles being fixed to the outermost layer of the intermediate resin layer.

The latter configuration includes a monolayered or multilayered configuration, including; for example, a configuration composed only of a colored layer, a configuration composed of the colored layer and a sealer layer serving as an adhesive layer, and a configuration composed of a clear layer serving as a light-resistant layer, the colored layer, and the sealer layer. Such an intermediate resin layer can be made from an acrylic resin, an acrylic silicone resin, a silicone resin, a fluorocarbon resin or the like that include a functional group (e.g., a carboxyl group, a carbonyl group, an alcoholic hydroxyl group, and a thiol group) that reacts with the silanol group included in the silica particles. In terms of the material costs and the like, it is preferable to use an acrylic resin or an acrylic silicone resin.

Here, in a preferred embodiment, the zinc oxide particle content in the ultraviolet protection layer is in the range of about 0.1 to about 1.0 g/m².

It has been found by the present inventors that an ultraviolet shielding rate of 90% or more can be achieved when the amount of the zinc oxide in the ultraviolet protection layer is about 1.0 g/m². Thus, it seems that this ultraviolet shielding rate can provide a durability of about 20 to about 30 years to the building material, and this is a necessary and sufficient level of the ultraviolet shielding effect. Therefore, the upper limit of the zinc oxide particle content is set to about 1.0 g/m².

On the other hand, it has also been determined by the present inventors that a sufficient ultraviolet shielding effect cannot be achieved when the zinc oxide particle content in the ultraviolet protection layer is less than about 0.1 g/m². Based on this, the lower limit of the zinc oxide particle content is set to about 0.1 g/m².

Preferably, the ultraviolet protection layer has a thickness in the range of about 2.0 to about 20.0 μm.

The thickness range of about 2.0 to about 20.0 μm is set from the viewpoints of the particle diameters of the silica particles and the zinc oxide particles contained in the ultraviolet protection layer and ensuring the transparency of the ultraviolet protection layer. It has been determined by the present inventors that a thickness exceeding about 20.0 μm impairs the transparency of the ultraviolet protection layer, resulting in an adverse effect on the appearance of the building material.

Preferably, the zinc oxide particles have an average particle diameter in the range of about 5.0 to about 35.0 nm. Preferably, the silica particles have an average particle diameter in the range of about 4.0 to about 20.0 nm.

The above-described upper and lower limits of the average particle diameter of the zinc oxide particles are set for the following reason. A diameter less than about 5.0 nm is not a universal grade (i.e., a grade that is sold on the market and is easily available) and thus increases the material costs. A diameter exceeding about 35.0 nm impairs the transparency of the ultraviolet protection layer. Here, an example of the method for determining the average particle diameter of the zinc oxide particles is a method in which a predetermined amount of the zinc oxide particles are observed with a TEM (transmission electron microscope) to measure the diameters of the particles, and an average value of the particle diameters is determined.

Meanwhile, the above-described upper and lower limits of the average particle diameter of the silica particles are set for the following reason. A diameter less than about 4.0 nm is not a universal grade and thus increases the material costs. A diameter exceeding about 20.0 nm impairs the transparency of the ultraviolet protection layer, thus making the ultraviolet protection layer to be easily clouded and also reducing the binder force. Here, an example of the method for determining the average particle diameter of silica particles is a method of determining a converted value from a measured value of a specific surface area (in accordance with JIS Z8830) obtained by the BET adsorption method (nitrogen adsorption method). In the case of using this method, the average particle diameter is determined by Average Particle Diameter (Specific Surface Area Diameter: D(nm))=2720/S (S is a specific surface area (m²/g)).

The embodiment is also directed to a method for producing a building material in which silica particles are fixed to a substrate or an intermediate resin layer, including: mixing silica particles, zinc oxide particles, a surfactant, alcohol, and water to produce a coating material; and applying the coating material to a surface of a substrate or a surface of an intermediate resin layer formed on the surface of the substrate, and drying the coating material, to form an ultraviolet protection layer in which the silica particles are disposed around the zinc oxide particles.

Here, in the drying step, it is possible to use the method of directly drying the coating material at high temperature by using air drying, a dryer or the like. It is also possible to use the method of drying the coating material by using the preheating that previously heats the substrate or the intermediate resin layer.

With the production method according to the embodiment, it is possible to produce a highly durable building material having both the self-cleaning effect and the ultraviolet shielding effect at a lower production cost compared with a building material that has been subjected to a fluorine coating treatment to provide the self-cleaning effect.

As is understood from the foregoing description, with the building material according to the embodiment, the ultraviolet protection layer on the surface of the substrate is configured as a whole by the silica particles, which are resistant to photoradicals, disposed around the zinc oxide particles. Accordingly, the silica particles serve as a binder to form the ultraviolet protection layer, and it is therefore possible to solve the concern of degradation of the substrate or the intermediate resin layer, and the ultraviolet protection layer by photoradicals, thus making it possible to provide a highly durable building material having self-cleaning performance and ultraviolet shielding performance.

Hereinafter, embodiments of the building material according to the present invention will be described with reference to the drawings.

### (Building Material According to Embodiment 1)

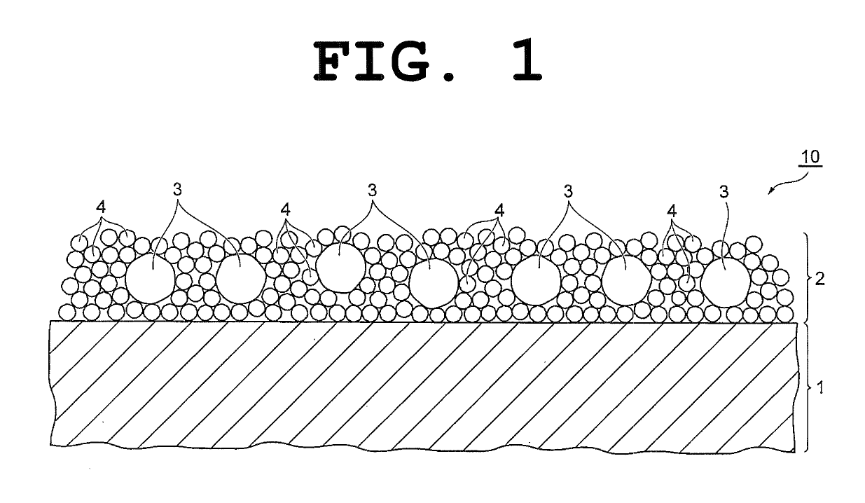

FIG. 1 is an enlarged vertical cross-sectional view of a part of a building material according to Embodiment 1 of the present invention.

A building material 10 shown in FIG. 1 is configured as a whole by an ultraviolet protection layer 2 formed on the surface of a substrate 1, and is used as a roof material, a wall material, a decorative material and the like that form a building.

The ultraviolet protection layer 2 is configured as a whole by silica particles 4 disposed around zinc oxide particles 3 by intermolecular force, and the silica particles 4 serve as a binder to connect the zinc oxide particles 3 to each other, and the silica particles 4 are hydrogen-bonded to the substrate 1 to connect the zinc oxide particles 3 to the substrate 1.

Here, the substrate 1 is made of a ceramic siding board (e.g., a wood fiber-reinforced cement board, a fiber-reinforced, cement board, a fiber-reinforced cement calcium silicate hoard, or a slag gypsum board) composed mainly of cement, an ALC (autoclaved lightweight concrete) board, a metal siding board composed mainly of metal, a resin board, or the like.

The zinc oxide particles 3 forming the ultraviolet protection layer 2 are particles having the ultraviolet shielding effect. On the other hand, the silica particles 4 have the self-cleaning effect of having excellent hydrophilicity, being less prone to stain attachment, and allowing attached stains to be easily washed off with rain water or the like. Colloidal silica, fumed silica, or the like are used as the silica particles 4.

The zinc oxide particles 3 having a particle diameter in the range of about 5.0 to about 35.0 nm are used, and the silica particles having a particle diameter in the range of about 4.0 to about 20.0 nm are used. Each of these numerical value ranges is set from the viewpoints of the material costs and ensuring the transparency of the ultraviolet protection layer 2.

The amount of the zinc oxide particles 3 contained in the ultraviolet protection layer 2 is adjusted to a range of about 0.1 to about 1.0 g/m². This numerical value range is set from the viewpoint of achieving a sufficient ultraviolet shielding effect.

Furthermore, the thickness of the ultraviolet protection layer 2 is adjusted to a range of about 2.0 to about 20.0 μm. This thickness range is set from the viewpoints of the particle diameters of the silica particles and the zinc oxide particles contained in the ultraviolet protection layer 2 and ensuring the transparency of the ultraviolet protection layer 2.

In the building material 10 shown in FIG. 1, the ultraviolet protection layer 2 on the surface of the substrate 1 is formed as a whole by the silica particles 4, which are resistant to photoradicals, disposed around the zinc oxide particles 3. Accordingly, the silica particles 4 serve as a binder to form the ultraviolet protection layer 2, and it is therefore possible to solve the concern of degradation of the substrate 1 or the ultraviolet protection layer 2 by photoradicals. Furthermore, the provision of the ultraviolet protection layer 2 having a structure in which the silica particles 4 surround the zinc oxide particles 3 makes it possible to protect the substrate 1 against the photoradicals generated from the zinc oxide particles 3, thus providing a building material exhibiting high durability in addition to having the ultraviolet shielding effect provided by the zinc oxide particles 3. Furthermore, the building material 10 also has the self-cleaning effect provided by the silica particles 4, thus contributing to a reduction in the maintenance costs.

Note that although fluorine-coated building materials are often used to provide the self-cleaning effect, it has been determined by the present inventors that the use of the ultraviolet protection layer 2 shown in FIG. 1 achieves a lower production cost compared with the use of fluorine coating.

Next, a method for producing the building material 10 will be described.

First, silica particles, zinc oxide particles, a surfactant, alcohol, and water are mixed to produce a coating material.

The coating material is applied to the surface of the substrate 1. Examples of the application method used here include application using a roll coater, or a flow coater, in addition to spray coating of the coating material.

After application of the coating material, alcohol and water are evaporated by performing drying under a temperature atmosphere of about 60° C., for example, to form, on the surface of the substrate 1, an ultraviolet protection layer 2 in which the silica particles 4 are bonded around the zinc oxide particles 3 and the zinc oxide particles 3 are connected to each other via the silica particles 4, thus producing a building material 10. Here, the ultraviolet protection layer 2 and the substrate 1 are connected by hydrogen bonding between the silica particles 4 and the substrate 1.

Note that in the drying step, it is possible to use a method of previously heating the substrate 1 to about 60° C. or above, and drying the coating material by using the preheating, in addition to the method of directly heating the coating material under the atmosphere of about 60° C.

### (Building Material According to Embodiment 2)

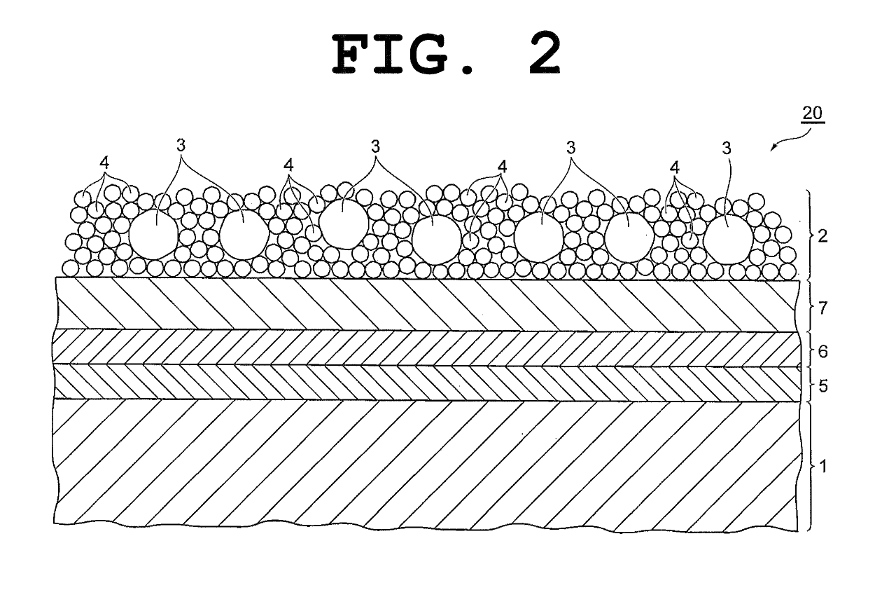

FIG. 2 is an enlarged vertical cross-sectional view of a part of a building material according to Embodiment 2 of the present invention.

A building material 20 shown in FIG. 2 is configured as a whole by a sealer layer 5 serving as an adhesive layer formed on the surface of a substrate 1, a colored layer 6 formed on the surface of the sealer layer 5, a clear layer 7 serving as a light-resistant layer formed on the surface of the colored layer 6, and an ultraviolet protection layer 2 formed on the surface of the clear layer 7.

Each of the sealer layer 5, the colored layer 6, and the clear layer 7 form an intermediate resin layer, which is made from an acryl-based resin such as an acrylic resin or an acrylic silicone resin. In addition to an acrylic resin and an acrylic silicone resin, a silicone resin and a fluorocarbon resin can also be used for such an intermediate resin layer. Theses resins are preferable resinous materials because they have a functional group (e.g., a carboxyl group, a carbonyl group, an alcoholic hydroxyl group, and a thiol group) that reacts with the silanol group included in the silica particles 4. Especially, it is preferable to use an acrylic resin or an acrylic silicone resin from the viewpoint of the material costs and the like.

In the building material 20 as well, the ultraviolet protection layer 2 on the surface of the clear layer 7 is formed as a whole by the silica particles 4, which are resistant to photoradicals, disposed around the zinc oxide particles 3. Accordingly, the silica particles 4 serve as a binder to form the ultraviolet protection layer 2, and it is possible to prevent the ultraviolet protection layer 2, as well as the sealer layer 5, the colored layer 6, and the clear layer 7, from being degraded by photoradicals, thus providing a highly durable building material.

### (Silica Particle Separation Test s and the Results)

The present inventors produced building materials according to Examples 1 to 3 and a building material according to a comparative example, and carried out the test for examining the presence or absence of separation of the silica particles forming the ultraviolet protection layer formed on the surface of each of the building materials (note, in the case of the comparative example, the layer corresponding to the ultraviolet protection layer is referred to as a self-cleaning layer because no zinc oxide particle for the ultraviolet shielding effect was provided in the layer).

### Example 1

An acrylic resin layer (enamel layer) was formed on the surface of a cement board serving as a substrate, and a coating material produced by mixing silica particles, zinc oxide particles, a surfactant, alcohol, and water was applied to the surface of the acrylic resin layer, and the coating material was dried, to form an ultraviolet protection layer composed of the zinc oxide particles and the colloidal silica particles. Note that the zinc oxide content Was about 0.1 g/m², the average particle diameter of the zinc oxide particles was about 25.0 nm, the average particle diameter of the colloidal silica particles was about 13.0 nm, and the average thickness of the whole ultraviolet protection layer thus formed was about 10.0 μm:

### Example 2

A building material was produced with the same constituent elements as those in Example 1, except that the zinc oxide content was about 0.3 g/m².

### Example 3

A building material was produced with the same constituent elements as in Example 1, except that the zinc oxide content was about 0.85 g/m².

### Comparative Example

An acrylic resin layer (enamel layer) serving as an intermediate resin layer was formed on the surface of a cement board serving as a substrate, to form the self-cleaning layer composed only of the colloidal silica particles. Note that as with the examples, the average particle diameter of colloidal silica particles is about 13.0 nm.

### <Testing Method>

Using a metaling vertical weather meter MV3000 (manufactured by Suga Test Instruments Co., Ltd.), irradiation with a light amount of 0.53 kW/m² was performed under an atmosphere of a temperature of 65° C. and a humidity of 70% for 20 hours, then the irradiation was rested for one hour, and a water spray was applied to the surface for one minute before and after dew condensation. Taking this series of operations as one cycle, a predetermined numbers of cycles shown in Table 1 were performed, and the color difference and the presence or absence of separation of the silica particles were observed. The color difference was measured using a spectrophotometer CM600d manufactured by KONICA MINOLTA, INC. Note that “separation of silica particles” refers to the phenomenon that degradation of the intermediate resin layer (acrylic resin layer (enamel layer)) underlying the ultraviolet protection layer or the self-cleaning layer reduces the degree of adhesion between the intermediate resin layer and the silica particles, thus causing the silica particles to be detached from the intermediate resin layer. The ultraviolet protection layer or the self-cleaning layer containing the silica particles and the underlying layer (intermediate resin layer) are in close contact by hydrogen bonding (hydrogen bonding between the silanol groups of the silica particles and the functional groups of the binder of the underlying layer) or the like. However, when the binder of the underlying layer is degraded by ultraviolet light, the silica particles likely to become detached from the underlying layer.

### <Test Results>

The test results are shown in Table 1 below.

TABLE 1

| | | | | | | Presence |
|---|---|---|---|---|---|---|
| | | | | | | or absence |
| | Zinc | | | | | of |
| | oxide | | | | | separation |
| | content | Color difference | | | | of silica |
| | (g/m²) | 0 cycles | 5 cycles | 20 cycles | 25 cycles | particles |
| Ex. 1 | 0.1 | 0 | 2.73 | 4.93 | 2.80 | A |
| Ex. 2 | 0.3 | 0 | 2.60 | 0.88 | 1.52 | A |
| Ex. 3 | 0.85 | 0 | 2.01 | 1.27 | 1.22 | A |
| Com. | 0 | 0 | 2.23 | 6.95 | 6.14 | B |
| Ex. | | | | | | |

Note:
“A” means that the silica particles remain bonded, and
“B” means that the silica particles have been separated.

As a result of the test, with regard to the presence or absence of separation of the silica particles, the separation of the silica particles was observed for the comparative example having the self-cleaning layer containing no zinc oxide, whereas for each of Examples 1 to 3, it was observed that the silica particles remained.

It seems that the comparative example contained no zinc oxide and therefore, the acrylic resin in the underlying layer was degraded by ultraviolet light, and the degradation of the underlying layer leads to the separation of the colloidal silica particles.

In contrast, it seems that each of Examples 1 to 3 has the zinc oxide content in the range of about 0.1 to about 1.0 g/m² in the ultraviolet protection layer, and thereby, the degradation of the acrylic resin in the underlying layer was prevented by a sufficient ultraviolet shielding effect provided by the zinc oxide particles and the photoradical resistance provided by the colloidal silica particles, thus contributing to the remain of the colloidal silica particles.

Meanwhile, with regard to the color difference, the color difference of the comparative example was greatly in excess of 3.0 at a stage at which the number of cycles exceeded 20, and it can thus be determined that the ultraviolet shielding effect cannot be expected. On the other hand, the color difference of each of Examples 1 to 3 is less than 3.0 at 25 cycles, and it can be determined that the sufficient ultraviolet shielding effect is achieved. This is presumably because the ultraviolet protection layer has the zinc oxide content in the range of about 0.1 to about 1.0 g/m², and therefore, the sufficient ultraviolet shielding effect by the zinc oxide particles was achieved.

Although embodiments of the present invention have been described above in detail with reference to the drawings, the specific configuration is by no means limited to these embodiments. Any design modification and the like made within a scope that does not depart from the gist of the invention are construed to be encompassed by the present invention.

What is claimed is:

1. A building material comprising:
a substrate; and
an ultraviolet protection layer containing zinc oxide particles and silica particles formed on a surface of the substrate,
wherein the silica particles in the ultraviolet protection layer are fixed to the surface of the substrate.

2. The building material according to claim 1,
wherein the silica particles are disposed around the zinc oxide particles in the ultraviolet protection layer.

3. The building material according to claim 1,
wherein a content of the zinc oxide particles in the ultraviolet protection layer is in a range of about 0.1 to about 1.0 g/m².

4. The building material according to claim 1,
wherein the ultraviolet protection layer has a thickness in a range of about 2.0 to about 20.0 μm.

5. The building material according to claim 1,
wherein the zinc oxide particles have an average particle diameter in a range of about 5.0 to about 35.0 nm.

6. The building material according to claim 1,
wherein the silica particles have an average particle diameter in a range of about 4.0 to about 20.0 nm.

7. The building material according to claim 1,
wherein the silica particles comprise a least one of colloidal silica and fumed silica.

8. The building material according to claim 1,
wherein the substrate is covered with an intermediate resin layer to form the surface of the substrate, and
the silica particles in the ultraviolet protection layer are fixed to the intermediate resin layer formed on the substrate.

9. The building material according to claim 8,
wherein the intermediate resin layer is made of at least one of an acrylic resin and an acrylic silicone resin.

10. The building material according to claim 1,
wherein the silica particles in the ultraviolet protection layer are directly fixed to the substrate.

11. A method for producing a building material comprising:
mixing silica particles, zinc oxide particles, a surfactant, alcohol, and water to produce a coating material;
applying the coating material to a surface of a substrate; and
drying the coating material to form an ultraviolet protection layer in which the silica particles are disposed around the zinc oxide particles.

12. The method for producing a building material according to claim 11,
wherein a content of the zinc oxide particles in the ultraviolet protection layer is in a range of about 0.1 to about 1.0 g/m².

13. The method for producing a building material according to claim 11,
wherein the ultraviolet protection layer has a thickness in a range of about 2.0 to about 20.0 μm.

14. The method for producing a building material according to claim 11,
wherein the zinc oxide particles have an average particle diameter in a range of about 5.0 to about 35.0 nm.

15. The method for producing a building material according to claim 11,
wherein the silica particles have an average particle diameter in a range of about 4.0 to about 20.0 nm.

16. The method for producing a building material according to claim 11,
wherein the silica particles comprise at least one of colloidal silica and fumed silica.

17. The method for producing a building material according to claim 11,
wherein the substrate is covered with an intermediate resin layer to form the surface of the substrate, and
the silica particles in the ultraviolet protection layer are fixed to the surface of the intermediate resin layer formed on the substrate.

18. The method for producing a building material according to claim 17,
wherein the intermediate resin layer is made of at least one of an acrylic resin and an acrylic silicone resin.

19. The method for producing a building material according to claim 11,
wherein the silica particles in the ultraviolet protection layer are directly fixed to the substrate.
